(19) United States
(12) Patent Application Publication
(10) Pub. No.: US 2020/0283127 A1
(43) Pub. Date: Sep. 10, 2020

(54) MULTIROTOR AIRCRAFT FOR MULTIPLE PAYLOAD DELIVERY

(71) Applicant: NEO AERONAUTICS PTE. LTD., Singapore (SG)

(72) Inventors: Damian CHENG, Singapore (SG); Wayne Mu En ONG, Singapore (SG); Charles C. Aravinda, Singapore (SG)

(73) Assignee: NEO AERONAUTICS PTE. LTD., Singapore (SG)

(21) Appl. No.: 16/508,034

(22) Filed: Jul. 10, 2019

(30) Foreign Application Priority Data
Jul. 10, 2018 (SG) 10201805915S

(51) Int. Cl. B64C 17/02; B64C 39/02; B64D 9/00; B64C 7/00

(52) U.S. Cl. CPC B64C 17/02; B64C 39/024; B64D 9/00; B64C 2201/128; B64C 2201/027; B64C 2201/042; B64C 2201/108; B64C 7/00

(57) ABSTRACT

According to various embodiments, there is provided a multi-rotor aircraft for a multiple payload delivery comprising a morphing mechanism having an airframe and at least three support arms coupled to the airframe wherein each support arm is configured for rotating about a vertical axis of the aircraft relative to the morphing mechanism. The aircraft further includes a payload bay coupled to the morphing mechanism for engaging and disengaging a plurality of payloads and a control system communicatively coupled with the morphing mechanism and the payload bay, wherein the control system is configured to cause each of the support arms to rotate by a predetermined angle about the vertical axis of the aircraft, wherein the predetermined angle is determined based on a change in distance between a neutral point and a centre of gravity of the aircraft.

### CROSS-REFERENCE TO RELATED APPLICATION

This application is a national application claiming priority benefit to Singapore Patent Application 10201805915S, filed on Jul. 10, 2018. The entire contents and disclosures of the above application are incorporated herein by reference.

### TECHNICAL FIELD

This invention relates to the field of stability augmentation for multirotor aircraft and in particular, to achieve constant neutral stability for a multirotor aircraft for a multiple payload delivery.

### BACKGROUND

The following discussion of the background of the invention is intended to facilitate an understanding of the present invention. However, it should be appreciated that the discussion is not an acknowledgement or admission that any of the material referred to was published, known or part of the common general knowledge of the person skilled in the art in any jurisdiction as at the date of the application.

Technology innovations in Unmanned Aerial Vehicles (UAVs) and drones have driven their increasing use to a range of applications. Particularly, UAVs have passed the boundaries of personal leisure and are frequently used in industrial applications such as inspection, agriculture, surveillance and transportation. UAVs are also dominant in the logistics sector as their capabilities facilitate autonomous transportation of goods which can reduce the required transportation time. As one such application, delivery drones are of particular interest with logistics and online retail companies such as Amazon Prime Air who may be planning to launch fleets of aerial delivery drones performing single deliveries. Recent improvements in UAV technology further extends the payload capacity and operating range of such aerial delivery drones, allowing them to process more than a single parcel and increasing coverage by eliminating multiple flights to complete the same task. Enabling multi-parcel delivery approaches therefore significantly reduce delivery cost and time.

The concept of morphing has been proposed for fixed-wing aircraft to alter the shape of airfoils (wings) for the purpose of improved flight characteristics and performance. These improvements in flight performance are mainly achieved by changes in wing aspect ratio or camber to ensure improved overall flight efficiency and higher lift to drag ratio throughout different aerodynamics conditions. Improvements in flight characteristics and handling qualities are achieved by ensuring a constant negative pitching moment coefficient for nose-heavy designs; and expansion the mission profile of a single aircraft to carry out multiple tasks and roles.

Despite the aforementioned advantages, the concept of morphing has yet to be applied onto multirotor aircraft such as Unmanned Aerial Vehicles (UAV) and drones to improve handling qualities and efficiency. The major hurdle in the development of a platform with multiple payload capability is the abrupt change in the Center of Gravity (CG). Unlike fixed-wing aircraft, it is difficult to achieve a stable and efficient flight with multirotor UAVs (M-UAVs) due to the changes in CG from the unequal weight distribution during the flight from each release of a payload from a combined payload. To achieve neutral stability for multirotor aircrafts and to correct any Centre of Gravity (CG) offset in the delivery of multiple payloads, the current methodology for conventional M-UAVs is through precise components mass balancing on the multirotor airframes or by having the flight controller perform compensation measures such as increasing the motor throttle output to re-balance all moments acting on a multirotor aircraft or by controlling the difference in throttle inputs between different rotors. Hence, power is wasted merely to balance the aircraft. While multirotor UAVs (M-UAVs) are currently deployed to handle delivery of parcels, such multirotor UAVs are mostly limited to single parcel deliveries due to changes in CG the M-UAV will experience when carrying and delivering multiple payloads. Therefore, if a M-UAV were to carry more than one parcel, it will be subjected to non-zero resultant forces and moments if the onboard payloads have unequal mass distributions, and lead to a detrimental flight behavior.

The present invention attempts to overcome or to address at least in part some of the aforementioned problems. Accordingly, it would be desirable to provide a multirotor aircraft with improved handling qualities and efficiency.

Accordingly, it would be desirable to provide a multirotor aircraft that has increased payload capability and multi-stop deliveries capability which increases coverage and significantly reduce delivery time and cost.

Accordingly, it would be desirable to provide a multirotor aircraft that is capable of delivering multiple parcels or multiple payloads without penalizing the aircraft flight performance.

### SUMMARY OF THE INVENTION

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to a first aspect of the present invention, there is a multi-rotor aircraft for a multiple payload delivery comprising:

a morphing mechanism comprising an airframe and at least three support arms coupled to the airframe, wherein each support arm is configured for rotating about a vertical axis of the aircraft relative to the morphing mechanism,
a payload bay coupled to the morphing mechanism for engaging and disengaging a plurality of payloads;
a control system communicatively coupled with the morphing mechanism and the payload bay, wherein the control system is configured to cause the support arms to movably rotate about the vertical axis of the aircraft between a first position where a first neutral point of the morphing mechanism is out of alignment with a centre of gravity of the aircraft and a second position where the first neutral point of the morphing mechanism is aligned with the centre of gravity of the aircraft.

Preferably, the support arms movably rotate about the vertical axis of the aircraft by a predetermined angle.

Preferably, the predetermined angle of the movement of each of the support arms is determined based on a distance between the first neutral point and the centre of gravity on a longitudinal axis of the aircraft in the first position.

Preferably, the support arms are in a Y-shaped configuration in the first position and the support arms are in a substantially T-shaped configuration in the second position.

Preferably, the support arms are in a substantially T-shaped configuration in the first position and the support arms in a Y-shaped configuration in the second position.

Preferably, the centre of gravity of the aircraft is based on the combined weight of the plurality of payloads and the aircraft.

Preferably, the first position is defined by a change in combined weight of the plurality of payloads and the aircraft in such a way as to cause the first neutral point of the morphing mechanism to be out of alignment with the centre of gravity of the aircraft.

Preferably, the morphing mechanism further comprises a front portion and a rear portion, wherein the front portion includes more support arms than the rear portion.

Preferably, the rotation of the support arms by a predetermined angle about the vertical axis of the aircraft is symmetric about the x-z plane of the aircraft.

In accordance with a second aspect of the present invention, there is a multi-rotor aircraft for a multiple payload delivery comprising:

a morphing mechanism comprising an airframe and at least three support arms coupled to the airframe wherein each support arm is configured for rotating about a vertical axis of the aircraft relative to the morphing mechanism;
a payload bay coupled to the morphing mechanism for engaging and disengaging a plurality of payloads;
a control system communicatively coupled with the morphing mechanism and the payload bay, the control system configured to cause each of the support arms to rotate by a predetermined angle about the vertical axis of the aircraft, wherein the predetermined angle is determined based on a change in distance between a neutral point and a centre of gravity of the aircraft.

Preferably, the change in distance between a neutral point and a centre of gravity lies on a longitudinal axis of the aircraft.

Preferably, each of the support arms rotate by a predetermined angle about the vertical axis of the aircraft between a first position where the neutral point is out of alignment with the centre of gravity of the aircraft and a second position where the neutral point of the morphing mechanism is aligned with the centre of gravity of the aircraft.

Preferably, the first position is defined by a change in combined weight of the plurality of payloads and the aircraft in such a way as to cause the neutral point of the morphing mechanism to be out of alignment with the centre of gravity of the aircraft.

Preferably, the support arms are in a substantially Y-shaped configuration in the first position and the support arms are in a substantially T-shaped configuration in the second position.

Preferably, the support arms are in a substantially T-shaped configuration in the first position and the support arms are in a substantially Y-shaped configuration in the second position.

Preferably, the morphing mechanism further comprises a front portion and a rear portion, wherein the front portion includes more support arms than the rear portion.

Preferably, the rotation of the support arms by a predetermined angle in the front portion of the morphing mechanism about the vertical axis of the aircraft is symmetric about the x-z plane of the aircraft.

Preferably, each support arm comprises at least one propeller motor for rotating at least one propeller to cause lift of the aircraft.

In accordance with a third aspect of the present invention, there is a method of achieving neutral stability in a multi-rotor aircraft for a multiple payload delivery, comprising the steps of:

receiving, by a controller unit of the aircraft, a combined weight data defined by a combined weight of a plurality of payloads and the aircraft, wherein the aircraft comprises a morphing mechanism having an airframe and at least three support arms coupled to the airframe;
determining, by the controller unit, a change in distance between a neutral point location and a centre of gravity location,
determining, by the controller unit, whether there is a change in distance between the neutral point location and the centre of gravity location;
determining, by the controller unit, a predetermined angle defined by a change in angle of each support arm, in response to determining that there is a change in distance between the neutral point location and the centre of gravity location;
outputting a signal from the controller unit to one or more actuators for causing each support arm to rotate by the predetermined angle about a vertical axis of the aircraft between a first position where the neutral point location is out of alignment with the centre of gravity location and a second position where the neutral point location is aligned with the centre of gravity location of the aircraft.

Preferably, the first position is defined by a change in combined weight of the plurality of payloads and the aircraft in such a way as to cause the neutral point of the morphing mechanism to be out of alignment with the centre of gravity of the aircraft.

Preferably, the support arms are in a substantially Y-shaped configuration in the first position and the support arms are in a substantially T-shaped configuration in the second position.

Preferably, the support arms are in a substantially T-shaped configuration in the first position and the support arms are in a substantially Y-shaped configuration in the second position.

Preferably, the rotation of the support arms by a predetermined angle in the front portion of the morphing mechanism about the vertical axis of the aircraft is symmetric about the x-z plane of the aircraft.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. The dimensions of the various features or elements may be arbitrarily expanded or reduced for clarity. In the following description, various embodiments of the invention are described with reference to the following drawings, in which:

FIG. 1 illustrates a perspective view of a multirotor aircraft according to various embodiments.

FIG. 2 illustrates a block diagram of a control system in communication with a remote communication device according to various embodiments.

FIG. 3 illustrates a specifications table of a multirotor aircraft according to various embodiments.

FIG. 4 illustrates a top and corresponding longitudinal views of a multirotor airframe configuration during stages (a) to (b) to (c) of a multiple payload delivery mission according to various embodiments.

FIG. 5A illustrates the relationship between a predetermined angle of each support arm and the change in distance between a neutral point and a centre of gravity location according to various embodiments.

FIG. 5B illustrates the functional relationship between the sweep angle θ and the distance, X_{NP}, between the CG location 30 and the NP location 31 of the aircraft on the x-y plane (or top view), which corresponds to the longitudinal view of the multirotor aircraft as shown in FIG. 5A.

FIG. 6A illustrates changes to the CG locations during the various stages of a multiple payload delivery mission of a multirotor aircraft without the implementation of a morphing mechanism according to various embodiments.

FIG. 6B illustrates changes to the CG locations during the various stages of a multiple payload delivery mission of a multirotor aircraft with the implementation of a morphing mechanism according to various embodiments.

FIG. 7 illustrates a comparison of calculated predetermined angles against the average predetermined angles between each rotor arm produced according to various embodiments.

FIG. 8 illustrates a method of achieving neutral stability in a multirotor aircraft through morphing the geometry of the multirotor aircraft when in operation according to various embodiments.

FIG. 9 illustrates a further method of achieving neutral stability in a multirotor aircraft through morphing the geometry of the multirotor aircraft when in operation according to various embodiments.

FIG. 10A illustrates a table showing a mission profile for the test flights according to various embodiments.

FIG. 10B illustrates a table showing morphing mechanism guidelines for the test flights of FIG. 10A.

FIG. 11 illustrates the validation results of the flight tests implemented with the morphing mechanism according to various embodiments.

FIG. 12 illustrates the validation results of Flight 2 shown in FIG. 10A falling within morphing mechanism guidelines according to various embodiments.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, and logical changes may be made without departing from the scope of the invention. The various embodiments are not necessarily mutually exclusive, as some embodiments can be combined with one or more other embodiments to form new embodiments.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media may include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

In the specification the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

In order that the invention may be readily understood and put into practical effect, particular embodiments will now be described by way of examples and not limitations, and with reference to the figures. It will be understood that any property described herein for a specific system may also hold for any system described herein. It will be understood that any property described herein for a specific method may also hold for any method described herein. Furthermore, it will be understood that for any system or method described herein, not necessarily all the components or steps described must be enclosed in the system or method, but only some (but not all) components or steps may be enclosed.

As used herein, the term “coupled” (or “connected”) herein may be understood as electrically coupled or as mechanically coupled, for example attached or fixed, or just in contact without any fixation, and it will be understood that both direct coupling or indirect coupling (in other words: coupling without direct contact) may be provided.

As used herein, the term “morphing” is generally defined as a radical change in the shape or geometry of an aircraft during flight to optimize performances. Types of changes include scale, chord, volume, bearing surface, thickness profile, elongation and planform. Morphing can be used as a control element by changing the shape of the aircraft in order to change the dynamics of flight.

As used herein, the term “payload” refers to any load carried by the UAV that may be removed from or repositioned on the UAV. Payload may include things that are carried by the UAV, including instruments, components, packages, temporary items for a limited duration of time. In addition, payload may include long term or permanent items necessary for the operation of the UAV. Payloads may be directly attached to the airframe of the UAV, such as a via a payload bay, a payload attachment fixture, or carried beneath the airframe by some means.

As used herein, the terms ‘multirotor aircraft’, multirotor UAV (M-UAV)” and drone are used interchangeably herein to refer to an unmanned aerial vehicle (UAV). A UAV may be configured to fly autonomously, semi-autonomously, or controlled wirelessly by a remote pilot system that is automated or manually controlled. A UAV may be propelled for flight in any number of known ways. For example, multiple propulsion units, each including one or more propellers, may provide propulsion or lifting forces for the UAV and any payload carried by the UAV. One or more types of power source, such as electrical, chemical, electro-chemical, or other power reserve may power the propulsion units.

As used herein, the “Centre of Gravity (CG)” refers to the point in, on, or near the UAV at which the whole weight of the UAV, including the payload, is acting irrespective of its position. A change in the CG of the UAV may provide balance, which may equate to stability and/or increased efficiency powering propulsion units during flight. When a body or object is present in a uniform gravitational field, then both the CG and centre of mass (CM) coincide with each other.

As used herein, the term “Neutral Point (NP)” is the position on the UAV where the moments from all forces balance to zero.

As used herein, the term “Neutral Static Stability” means that an aircraft will tend to stay in its most recently commanded attitude or condition, without oscillations, and will never tend to return to its previous state or diverge from its new attitude.

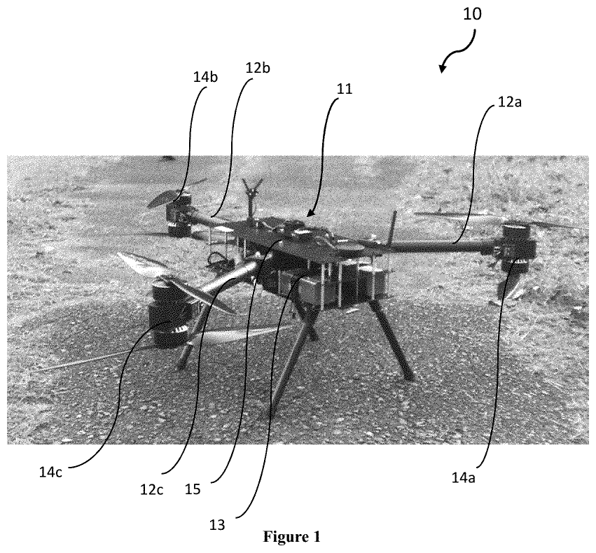

Various embodiments relate to a multirotor aircraft capable of multi-stop delivery of multiple payloads, and/or a method for adjusting a neutral point of an aircraft to accommodate changes in the position of the center of gravity. A major hurdle in the development of a platform with multiple-payload capability is the abrupt changes in Center of Gravity (CG) each time one or more payloads are released from a multirotor aircraft. Unlike fixed-wing aircraft, multirotor UAVs (M-UAV), such as the examples shown in FIG. 1, achieve stable and efficient flight when the Neutral Point (NP) coincides with the CG. For M-UAVs, the NP is defined as the location on the aircraft where the moments from all forces balance to zero. By morphing the airframe of a M-UAV, the NP position of the M-UAV can be adjusted continuously to account for the varying CG position while maintaining a balanced thrust distribution of all rotors. The latter is key to ensuring operation of all rotors within their optimal speed range. Hence, the proposed embodiments of the invention ensures constant neutral static stability which is essential for a safe and at the same time efficient operation of M-UAVs.

In various embodiments, in order to accommodate the abrupt changes in the CG during flight from weight distribution change of the payload and the M-UAV, the geometry of the airframe of the aircraft can be altered by adjusting the angle between the support arms. In various embodiments, the change in the angle between the support arms directly affects the NP location along the longitudinal direction of the M-UAV in such a way that the NP location can be movably aligned with the variable CG positions to maintain balanced throttle inputs to all rotors which in turn enhances the aircraft flight characteristics with regards to its stability and flight endurance.

Various embodiments may be implemented on different types of multirotor aircraft, such as a co-axial aircraft, for example, a tri-copter, a quad-copter or a multi-rotor aircraft. According to various embodiments, there is a multirotor aircraft 10, for example, a co-axial tri-copter aircraft, as depicted in FIG. 1 for carrying and dropping multiple payloads. The multirotor aircraft 10 comprises a morphing mechanism 11 including an airframe 15, at least three support arms, 12a, 12b and 12c, and at least one payload bay 13 for holding and transporting goods such as parcels, food or medicine for delivery to an intended destination. Each support arm 12a, 12b, 12c, includes an air propulsion unit 14a, 14b, 14c, each mounted on the distal end of the support arm. Each of the air propulsion units 14a, 14b 14c, includes at least a propeller for vertical and/or horizontal propulsion. Additionally, varying levels of power may be supplied to each of the air propulsion units 14a, 14b, 14c, for controlling stability and maneuverability during take-off, landing, and in flight.

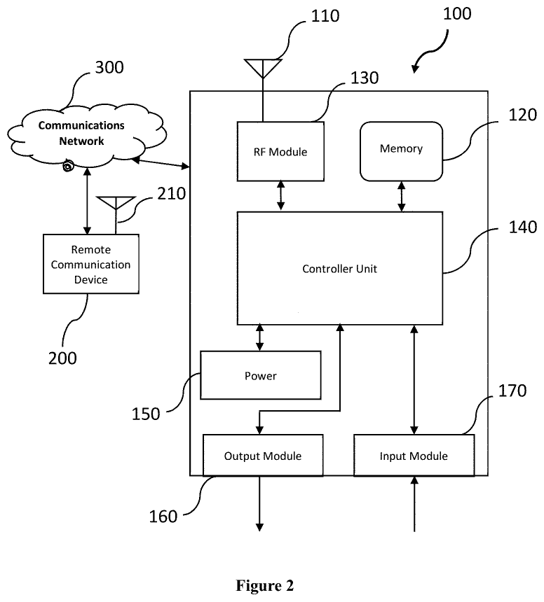

FIG. 2 is a block diagram of a control system 100 and a remote communication device 200 in communication with a network 300 according to various embodiments. The airframe 15 supports various other components (not shown), for example, actuators, power sources, cameras/sensors, circuit elements, and communication systems such as electronic speed controls and navigation systems. The airframe 15 includes a control system 100 that is communicatively coupled with the morphing mechanism 11, support arms 12a, 12b, 12c, payload bay 13 and propulsion units 14a, 14b, 14c. The control system 100 is communicatively coupled with a remote communication device 200 over a network 300. The control system 100 includes a controller unit 140 that is configured to control the movement of each support arm by adjusting the sweep angle of each support arm to balance the CG position and NP position of the aircraft, details of which will be provided hereinafter. The controller unit 140 is configured to determine the CG positions and NP positions of the aircraft based on the weight distribution of its combined payload and aircraft. In some embodiments, the controller unit 140 may include or be coupled to one or more radio frequency transceivers (for example, Bluetooth, BLE, ZigBee, Wi-Fi, RF radio, etc.) and an onboard 110 antenna for sending and receiving communications. For example, in some embodiments, the onboard antenna 110 may receive control signals for activating or controlling the controller unit 140. The onboard antenna 110 may transmit status information about the weight of the payload, CG and NP positions and other data, such as information collected by a sensor.

The controller unit 140 may include a power module 150 and a radio frequency (RF) module 130. The controller unit 140 may be a processor that may include a memory 120. The processor conducts various control and computing operations for controlling the movement or rotation of the support arms about the vertical axis of the aircraft. The controller unit 140 may be powered by the power module 150 or a power source outside the controller unit or a combination thereof. The controller unit 140 may communicate with the remote communication device 200 through the RF module 130. The onboard antenna 110 may be used to establish a wireless link to a remote antenna 210 of the remote communication device 200. The remote communication device 200 may be a device located remotely from the UAV. The RF module 130 may support communications with multiple remote communication devices 200. It will be understood by the skilled person in the art that while various components of the controller unit 140 are shown as separate components, in various embodiments, some or all of the components may be integrated together in a single device, chip, circuit board, or system-on-chip.

In various embodiments, the controller unit 140 may include an input module 170 which may be used for a variety of applications. For example, the input module 170 may receive images or data from an onboard image capturing device or camera or sensor, time of flight sensors, infrared sensors, thermal sensors, accelerometers, pressure sensors, or may receive electronic signals from other components such as the payload. Multiple input modules may be present and controlled by the controller unit 140.

In various embodiments, the controller unit 140 may include an output module 160. The output module may be used to activate components, for example, an actuator, an indicator, a sensor, a camera, a payload bay, etc. In various embodiments, servo actuators, for example, Linear Servo Actuators (LSAs), are configured to actuate the movement or rotation of each of the support arms about the vertical axis of the aircraft. Components activated by the output module may be configured to allow the neutral point of the multirotor aircraft to shift along its longitudinal axis to align the varying center of gravity positions arising from multiple and different payloads thereby resulting in greater efficiency in flight and power distribution to the motors of a multirotor aircraft. By morphing the airframe of a multirotor aircraft, in particular, adjusting the sweep angle of each of the support arms from one another, the NP position of the multirotor aircraft can be adjusted continuously to account for the varying CG position while maintaining a balanced thrust distribution of all rotors, ensuring a constant neutral static stability which is essential for a safe and efficient operation of multirotor aircraft such as M-UAVs.

As used herein, the term ‘network’ refers to a Local Area Network (LAN), a Metropolitan Area Network (MAN), a Wide Area Network (WAN), a Low Power Wide Area Network (LPWAN), a cellular network, a proprietary network, and/or Internet Protocol (IP) network such as the Internet, an Intranet or an extranet. Each device, module or component within the control system may be connected over a network or may be directly connected. A person skilled in the art will recognize that the terms ‘network’, ‘computer network’ and ‘online’ may be used interchangeably and do not imply a particular network embodiment. In general, any type of network may be used to implement the online or computer networked embodiment of the present invention. The network may be maintained by a server or a combination of servers or the network may be serverless. Additionally, any type of protocol (for example, HTTP, FTP, ICMP, UDP, WAP, SIP, H.323, NDMP, TCP/IP) may be used to communicate across the network. The devices as described herein may communicate via one or more such communication networks. The communication over the network may utilize data encryption. Encryption may be performed by way of any of the techniques available now available in the art or which may become available.

The controller unit 140 includes a memory 120 configured to store executable instructions, data, flight paths, flight control parameters, center of gravity information, neutral point information, weight of payload, angle of adjustment information, and/or data accessible by the controller unit. In various embodiments, the memory 120 may be implemented using any suitable memory technology, for example, a volatile memory such as a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magneto resistive Random Access Memory) or a PCRAM (Phase Change Random Access Memory). In some embodiments, program instructions and data implementing desired functions, are stored within the memory as program instructions configured to implement example routines or sub-routines, data storage for determining flight paths, landing, identifying locations for disengaging payloads, etc, and flight controls, respectively. In other embodiments, program instructions, data, flight controls may be received, sent or stored on different types of computer accessible media, such as non-transitory media, or on similar media separate from the memory or the control system.

As used herein, the term ‘processor’ broadly refers to and is not limited to single or multi-core general purpose processor, a special purpose processor, a conventional processor, a graphical processing unit, a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit, a system on a chip (SOC), and/or a state machine.

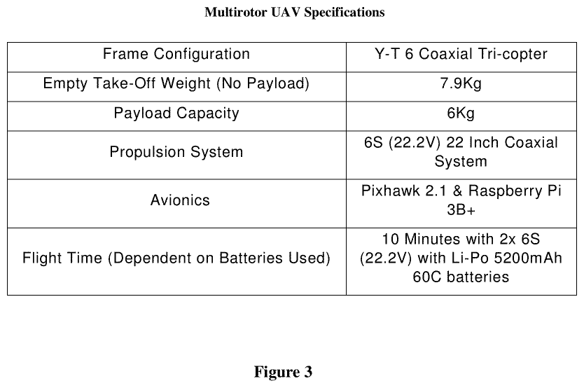

In some embodiments, an example of a multirotor aircraft 10 preferably consists of the following specifications as set out in FIG. 3. In various embodiments, and in operation, the multirotor aircraft may be configured to automatically adjust the sweep angle of each of the support arms to allow the neutral point (NP) of the multirotor aircraft to be adjusted continuously by shifting the NP along its longitudinal axis to align the varying center of gravity positions arising from multiple and different payloads. For example, the controller unit 140, through the input module 170, may receive an input indicating that the multirotor aircraft is out of balance or not in a position of neutral stability. The input may include sufficient information for the controller unit to determine a neutral point position that is out of alignment with the aircraft's current center of gravity position. Additionally, the controller unit 140 may determine the sweep angle of each of the support arm, or in other words, how much each of the support arms should rotate or move from its current position about the vertical axis of the aircraft, in order to to restore balance or achieve neutral stability. In response to determining how much each of the support arms should rotate, the controller unit may output a NP adjustment signal, such as through the output module 160, to cause the actuators in each of the support arm to adjust the sweep angle of each of the support arms by a predetermined angle.

In some embodiments, the controller unit 140 may receive remote instructions, such as from the RF module 210 of the remote communication device 200, for dynamically adjusting the NP position to align with the CG position. For example, the remote communication device 200 may transmit instructions to or otherwise communicate with the controller unit 140. In this way, the remote communication device 200 may include or be coupled to a remote processor (not shown) configured to determine a neutral point position that is out of alignment with the aircraft's current center of gravity position. For example, the remote communication device 200 may be a computing device, for example, a portable computing device, a smart phone, a laptop, a tablet, or similar electronic devices, and/or be coupled to another remote computing device which may include another remote processor. When a signal is received indicating that the multirotor aircraft is out of balance or not in a position of neutral stability, the remote processor within the remote communication device 200 may output a signal that may be transmitted, such as via the network 300, to the controller unit 140 onboard the multirotor aircraft. The signal may cause the controller unit 140 to output a NP adjustment signal, such as through the output module 160, to cause the actuators in each of the support arm to adjust the sweep angle of each of the support arms by a predetermined angle in order to restore balance or achieve neutral stability.

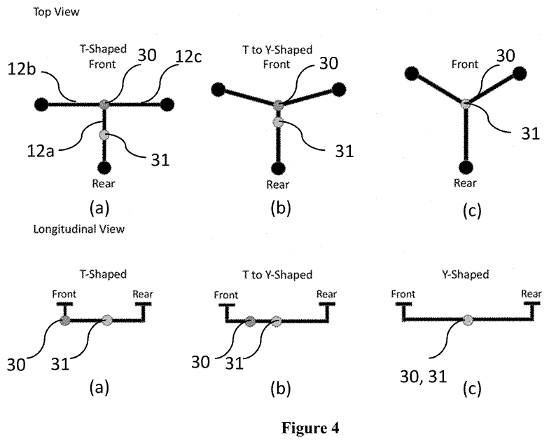

FIG. 4 shows the top views and corresponding longitudinal views of an example embodiment of a multirotor aircraft. In some embodiments, and as shown in FIG. 4, the multirotor aircraft is of a co-axial tricopter configuration. According to various embodiments, the concept of morphing the geometry of a tricopter configuration can be implemented by changing the geometry of the front two support arms 12b and 12c. In some embodiments, a Y-shaped tricopter (as shown in (c)) has three equal support arms that are spaced 120 degrees apart. Similarly, a T-shaped (as shown in (a)) tricopter also has three aupport arms but the front two arms 12b and 12c are spaced 90 degrees apart from the rear support arm 12a. In some embodiments, by sweeping the front two arms 12b and 12c of a T-shaped tricopter, morphing from a T to Y-shaped configuration, i.e., from (a) to (b) to (c) as shown in FIG. 4, will cause the NP location 31 of the multirotor aircraft to shift towards its center of gravity (CG) 30 as shown in the corresponding longitudinal views of (a) to (b) to (c). The adjustment of the sweep angle between each motor arm 12b and 12c therefore produces different shape configurations of the motor arms as shown in the exemplary co-axial Y6 Tricopter configuration as illustrated in FIG. 4. In some embodiments, for a multirotor aircraft with three motor arms, the shape configurations comprise a T-shaped configuration (FIG. 4(a)), a T to Y-shaped configuration (FIG. 4(b)) and a Y-shaped configuration (FIG. 4(c)).

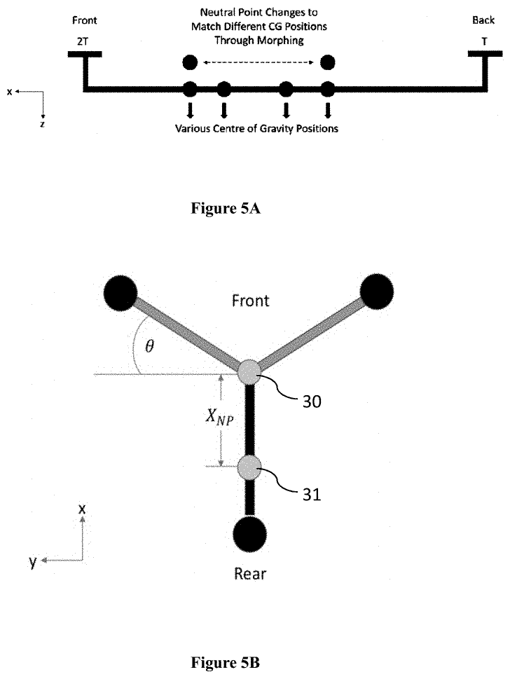

FIG. 5A illustrates the variation of the neutral point (NP) locations of a multirotor aircraft on a longitudinal axis of the aircraft by morphing between a Y-shaped and T-shaped configuration tri-copter on the x-z plane (or longitudinal view). In some embodiments, the front portion of the aircraft comprises two support arms while the rear portion comprises one support arm. When the multirotor aircraft is out of balance or not in a state of neutral stability, the NP location will be out of alignment with the CG location. For example, the NP location may be towards the distal ends of the front portion or the rear portion of the aircraft, depending on the change in weight distribution of the aircraft. For a multiple payload delivery, the multirotor aircraft will experience varying CG locations as a result of the weight distribution changes or change in combined weight of payloads from the unloading of one or more payloads from the payload bay for each delivery. This will also result in varying or changing NP locations each time the weight distribution of the combined payload changes from the unloading of one or more payloads from the payload bay. By adjusting the sweep angle of the front two support arms by a predetermined angle, this will cause the actuators in each support arm to move or rotate the support arm about the vertical axis of the aircraft by the predetermined angle in such a way so as to dynamically adjust the NP location to align with the current CG location of the aircraft.

FIG. 5B illustrates the functional relationship between the sweep angle θ and the distance, X_{NP}, between the CG location 30 and the NP location 31 of the aircraft on the x-y plane (or top view), which corresponds to the longitudinal view of the multirotor aircraft as shown in FIG. 5A. In some embodiments, FIG. 5B shows the control variables for a control system used on a multirotor aircraft, where X_{NP} is the distance between the CG location 30 of the morphing mechanism and NP location 31 of the aircraft, and θ is the change in angle between each support arm. In some embodiments, θ is the sweep angle of the front two support arms with respect to the T-shaped tricopter configuration. In some embodiments, the front two support arms are rotated about the vertical axis of the aircraft by the predetermined angle θ in a symmetric manner in the x-z plane of the aircraft. Assuming constant throttle input at the motors and the multirotor aircraft platform to be symmetric in the x-z plane, the change in distance of a neutral point from a pivot point, X_{NP}, of the multirotor aircraft along a longitudinal axis with respect to the angles between the support arms is determined according to the following formulation:

X_{NP}=−(5.9)·θ+167

θ=−(0.192)·X_{NP}+30

where
X_{NP}=neutral point distance from the CG location (mm)
θ=change in angle between each support arm (Degree)

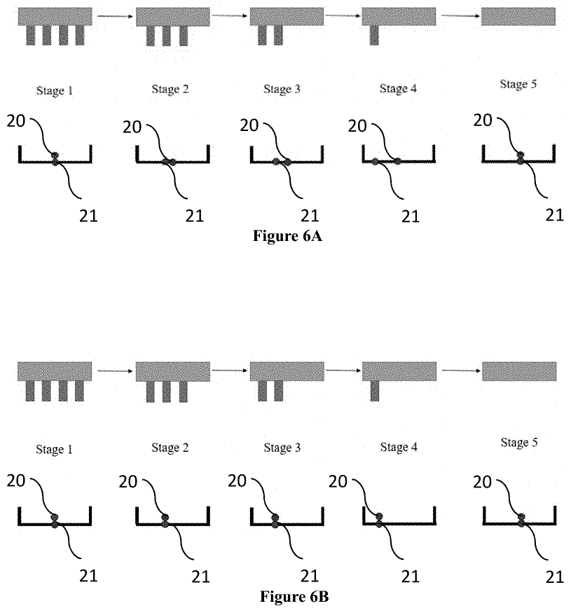

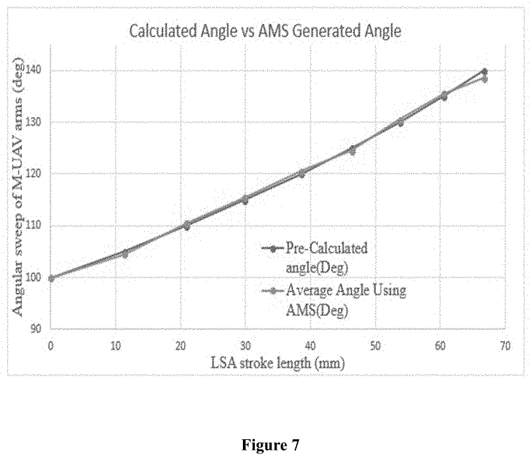

According to various embodiments, the predetermined angle θ between each support arm is adjustable in order to align a neutral point location of the multirotor aircraft and at least one center of gravity location of the multirotor aircraft to achieve constant zero pitching moment, regardless of the support arm length, and neutral static stability of the multirotor aircraft, assuming constant throttle input. In some embodiments, actuators, for example, linear servo actuators (LSAs) are utilized to adjust the sweep angles between each support arm. LSAs can hold a higher load compared to conventional servos and are therefore better suited to ensure accurate setting of the sweep angle. However, as LSAs have no built-in potentiometer, the extension of the actuator is controlled by a positive voltage input source. To retract the actuator, the polarity of the voltage source must be reversed. As each LSA produces varying but repeatable stroke lengths due to manufacturing issues, a calibration phase is required. FIG. 6 shows the results of the experimental implementation of the LSAs on a M-UAV and illustrates a comparison of calculated angles against the average angles produced by the present invention. The angle θ is measured and compared against theoretical predictions of θ. The experimental tests further demonstrated that a symmetric control of the commanded morphing angles can be achieved using LSAs.

FIG. 6A illustrates changes to the CG location during the various stages of a multiple payload delivery of a multirotor aircraft without the implementation of the morphing mechanism or specifically, with no adjustments to the sweep angle of the support arms during the flight. Particularly, during a multiple payload delivery mission from Stage 1 to Stage 4, it was observed that the CG location 21 of a M-UAV shifts in front of the NP location 20 after one payload is released from the payload bay due to the change in weight distribution. Specifically, the CG location 21 of the M-UAV shifts towards the distal end of the aircraft or towards the distal end of the front portion of the aircraft as more payloads are released from the payload bay and the aircraft becomes more nose heavy. To resolve this instability, the onboard controller unit of the M-UAV would normally perform compensation measures by controlling the difference in throttle inputs between the different motor arms. This, however, leads to unequal mass distributions which in turn leads to inefficiencies and a detrimental flight behavior.

FIG. 6B illustrates changes to the CG locations and NP locations during the various stages of a multiple payload delivery mission of a multirotor aircraft with the implementation of a morphing mechanism or a change in geometry of the M-UAV to adapt to the various stages 1 to 4 of a multiple payload delivery mission. This change in geometry allows the M-UAV to move its NP location 20 towards the distal end of the front portion of the aircraft to balance the CG location 21 offset as illustrated in FIG. 6B at different stages of a multiple payload delivery mission. In other words, by adjusting the sweep angle of the front two support arms by a predetermined angle, this will cause the actuators in each of the front two support arms to move or rotate each support arm about the vertical axis of the aircraft by the predetermined angle in such a way so as to dynamically adjust the NP location 20 to align with the CG location 21 offset of the aircraft. For example, from stage 1 to stage 2, the aircraft makes a delivery by releasing one payload from its payload bay which changes the weight distribution of the aircraft and in turn shifts the CG position 21 towards the distal end of the front portion of the aircraft. The transition from stage 1 to stage 2 will cause the NP location 20 to be out of alignment with the change in CG location. In some embodiments, the multirotor aircraft is configured to automatically adjust the sweep angle of each of the from two support arms to allow the neutral point location 20 of the multirotor aircraft to be adjusted continuously along its longitudinal axis until it aligns with the center of gravity location arising from the change in payload. For example, the controller unit 140, through the input module 170, may receive an input indicating that the NP location 20 of the multirotor aircraft is out of alignment with the change in CG location 21. The input may include sufficient information for the controller unit 140 to determine a NP location 20 that is out of alignment with the aircraft's current center of gravity location. Additionally, the controller unit 140 may determine the sweep angle of each of the front two support arms, or in other words, how much each of the front two support arms should rotate or move from its current position about the vertical axis of the aircraft, in order to align the NP location with the CG location 21. In response to determining how much each of the front two support arms should rotate, the controller unit 140 may output a NP adjustment signal, such as through the output module 160, to cause the actuators in each of the support arm to adjust the sweep angle of each of the support arms by the predetermined angle such that the NP location 20 is aligned with the CG location 21. This maintains a balanced thrust distribution of all rotors and ensures constant neutral static stability which is essential for a safe and efficient operation of the multirotor aircraft.

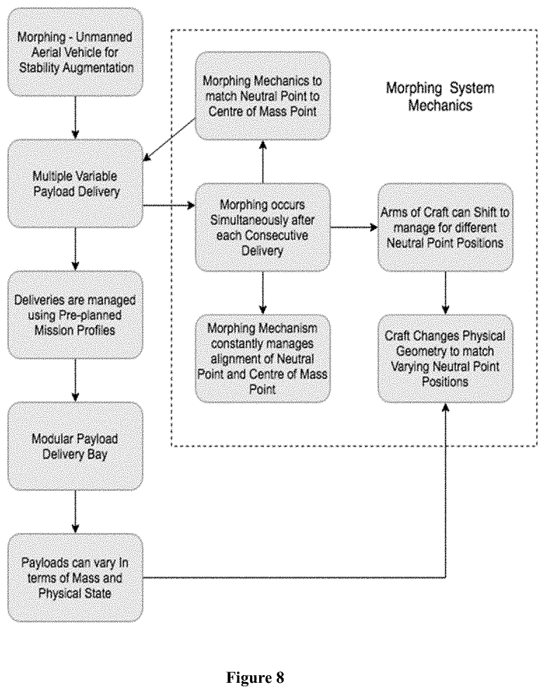

FIG. 8 illustrates a method for morphing a multirotor aircraft when in operation. According to various embodiments, there is a method for morphing the geometry of a multirotor aircraft when in operation. During operation, the multiple payloads of varying mass, physical states and mission profiles is pre-determined and pre-planned. The multiple payload of differing masses and physical states are then loaded on the payload bay 13 of the multirotor aircraft. Prior to take off, the support arms of the multirotor aircraft are adjusted to adopt either a T-shaped configuration, a T to Y-shaped configuration or a Y-shaped configuration accordingly to align a neutral point location of the multirotor aircraft with the center of gravity location of the multirotor aircraft to achieve constant neutral static stability of the multirotor aircraft. After a payload from the multiple payload is delivered and released from the payload bay, the center of gravity location of the multirotor aircraft shifts. The multirotor aircraft comprises a morphing mechanism that is configured to autonomously adjust the sweep angle between each support arm in accordance with the formulation described above to align a neutral point location of the multirotor aircraft with the center of gravity location of the multirotor aircraft to achieve constant neutral static stability of the multirotor aircraft. The multirotor aircraft is further configured to carry out the adjustment of the sweep angle between each motor arm in continuous mode, whether in a grounded or landing position or in mid-air.

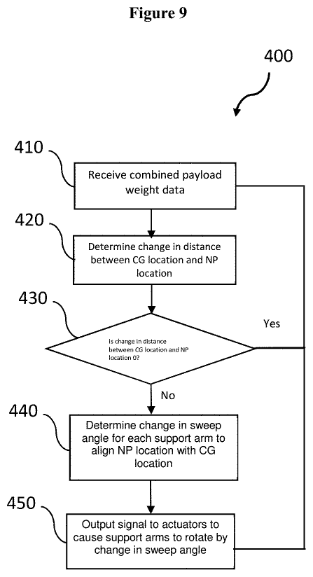

FIG. 9 illustrates a method 400 for achieving neutral stability in a multirotor aircraft according to various embodiments. According to various embodiments, the operations of the method 400 may be performed by a controller unit of a multirotor aircraft or a remote computing device in communication with the controller unit over a network, and one or more actuators for causing at least two support arms to move or rotate about a vertical axis of the aircraft by a predetermined angle such that the neutral point location can be aligned with a center of gravity location of the aircraft.

At step 410, the controller unit 140 may receive an input signal from a sensor of the aircraft or from a remote communication device that relates to a combined payload weight data. The input signal may be received from a remote source, such as through a wireless communication over the network, or from an onboard sensor from onboard components, or manually from an operator of the UAV. The combined payload weight data may include raw or processed data, such as one or more values indicating a change in weight of the combined payload or a weight of the combined payload of the aircraft at a point in time. In some embodiments, the input signal may be received in response to an initial or changed weight of the combined payload of the aircraft. For example, when a UAV makes a multiple payload delivery mission and one or more payloads have been released from the payload bay of the aircraft, the controller unit receives the combined payload weight data. In this way, the controller unit may receive an input signal before the aircraft takes flight, during a flight from one location to another, after landing but before a subsequent flight, or any other suitable time. In some embodiments, the controller unit may receive the combined payload weight data during flight or just after take-off in order to make adjustments or refinements to the support arms of the aircraft. This provides for mid-air adjustments during the flight to accommodate for changes in shifting payload or contents, consumption of fuel, changing external forces (eg. wind or turbulence) or weather conditions. The controller unit therefore provides an active continuous adjustment of the neutral point location towards the alignment of the shifting CG location as and when there is a change in the combined payload weight data.

At step 420, the controller unit may determine a change in distance between the CG location and the NP location of the aircraft based on the combined payload weight data. The controller unit may determine the change in distance between the CG location and the NP location at any suitable time, including before take-off, after lift-off, mid-flight or after landing. For example, the controller unit may access a memory for current or past CG locations based on predetermined combined payload weight data. This allows the controller unit to determine the change in distance between the NP location and the changed CG location. If the change in distance between the CG location and the NP location is 0 or substantially close to 0, at step 430, no adjustment or refinements to the support arms are required and the combined payload weight data may be received at any other suitable time to start step 410 again. If the change in distance between the CG location and the NP location is not 0 or substantially close to 0, at step 440, the controller unit will determine the change in sweep angle for each support arm based on the data relating to the change in distance between the CG location and the NP location. The change in sweep angle for each support arm is the predetermined angle by which the support arm has to be moved or rotated about the vertical axis of the aircraft in order to shift and to align the NP location with the CG location. Once the change in sweep angle is determined by the controller unit, at step 450, the controller unit will output a signal to the actuators to cause each support arm to move or rotate about the vertical axis of the aircraft by the change in sweep angle. By changing the sweep angle for each support arm by a predetermined angle, the NP location will shift towards the direction of the CG location so as to align the NP location with the CG location.

### Test Results

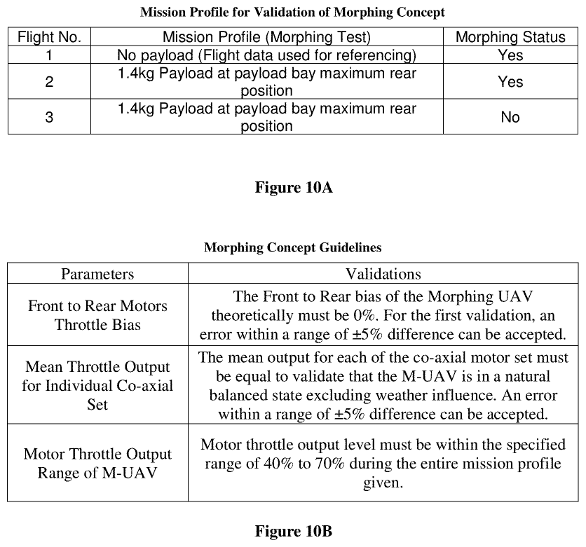

Test flights were carried out to validate the achievement of neutral stability in a multirotor aircraft using the morphing mechanism. FIG. 10A illustrates a table showing a mission profile for the test flights. In the test flights, flight data from Flight 1 was used as the reference data for subsequent flights to be compared with. FIG. 10B illustrates a table showing the guidelines that were designed for the morphing mechanism. These guidelines focus on the Stability and Operating Efficiency of the multirotor aircraft. Parameters such as the front to rear motor throttle bias, motor throttle output levels and motor throttle output range were specifically monitored.

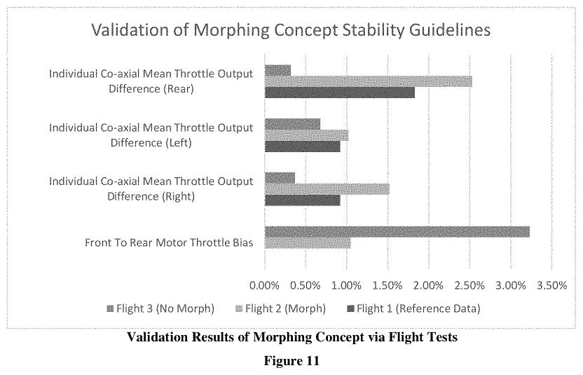

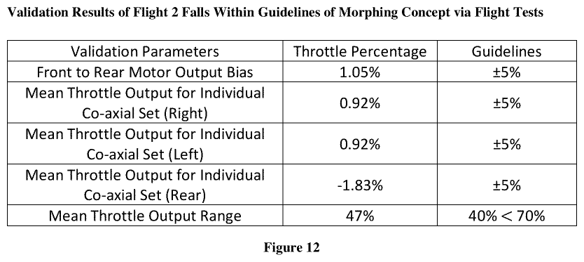

FIG. 11 illustrates the validation results of the morphing mechanism based on the test flights of FIG. 10A. From the flight test results shown in FIG. 11, flight results with morphing (Flight 2) have lower motor output bias compared to Flight 3 without morphing and it shares identical motor throttle output response from the reference data used from Flight 1 compared with the flight without morphing (Flight 3). The key parameter that was validated was the front to rear motor throttle bias. A zero-percentage value indicates that the multirotor aircraft is in a neutral static stable condition (Flight 1). With morphing and payload parameters introduced during Flight 2, the front to rear motor throttle bias was only 1.02% compared to Flight 3 of 3.83% without morphing. Guidelines results from Flight 2 as shown in FIG. 12 also indicate that all monitored parameters fall within the morphing guidelines.

The above flight data results validate that the concept of morphing a multirotor aircraft allows the aircraft to obtain a constant neutral static stable condition and also operate efficiently. Therefore, the proposed morphing concept improves the flight characteristics of a multirotor aircraft similar to the morphing of conventional fixed-wing aircraft.

The present invention provides the following advantages:—
1. Unlike aircraft, which prefers a constant negative pitching moment coefficient following a nose-heavy design, a multirotor aircraft gains improved performance with a neutral static stability. By adjusting the geometry of a multirotor airframe, a multirotor aircraft's flight characteristics can be enhanced. The NP location on a multirotor aircraft can be shifted by adjusting the sweep angle of the support arms. With the morphing mechanism, constant neutral static stability was achieved regardless of the CG location and the type of airframe used.
2. A morphing aircraft and concept guideline were developed and validated to improve stability augmentation with multiple payloads. This invention opens the possibilities of a multirotor aircraft which has the capabilities to carry multiple payloads with different and individual payloads while still preserving excellent flight characteristics.
3. The morphing platform is modular which allows it to work with other mission types that require the aircraft to adapt to varying stability requirements. Additional modules can also be attached to the aircraft to allow for different mission profiles. An example of this would be a water-specimen collecting unit. The parcels can be replaced with a holding tank as well as a pump system. The morphing platform can also compensate for the volatility of water that would affect the stability of the aircraft.
4. Additional modules can also enable the aircraft to perform the collection and delivery of dangerous substances between various locations.

It should be appreciated by the person skilled in the art that the above invention is not limited to the embodiment described. In particular, the following modifications and improvements may be made without departing from the scope of the present invention:
Aero-elastic materials for the airframe and/or a sliding payload bay could be utilized to further improve stability and endurance of the multirotor aircraft.
Currently the Automatic Morphing System (AMS) is used for the Stability Augmentation System (SAS). With the validation completed, further improvement could be made to integrate the AMS into the flight controller system which reduces the number of controllers used and the overall weight.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A multi-rotor aircraft for a multiple payload delivery comprising:
a morphing mechanism comprising an airframe and at least three support arms coupled to the airframe, wherein each support arm is configured for rotating about a vertical axis of the aircraft relative to the morphing mechanism,
a payload bay coupled to the morphing mechanism for engaging and disengaging a plurality of payloads;
a control system communicatively coupled with the morphing mechanism and the payload bay, wherein the control system is configured to cause the support arms to movably rotate about the vertical axis of the aircraft between a first position where a first neutral point of the morphing mechanism is out of alignment with a centre of gravity of the aircraft and a second position where the first neutral point of the morphing mechanism is aligned with the centre of gravity of the aircraft.

2. The multi-rotor aircraft according to claim 1, wherein the support arms movably rotate about the vertical axis of the aircraft by a predetermined angle.

3. The multi-rotor aircraft according to claim 2, wherein the predetermined angle of the movement of each of the support arms is determined based on a distance between the first neutral point and the centre of gravity on a longitudinal axis of the aircraft in the first position.

4. The multi-rotor aircraft according to claim 1, wherein the support arms are in a Y-shaped configuration in the first position and the support arms are in a substantially T-shaped configuration in the second position.

5. The multi-rotor aircraft according to claim 1, wherein the support arms are in a substantially T-shaped configuration in the first position and the support arms in a Y-shaped configuration in the second position.

6. The multi-rotor aircraft according to claim 1, wherein the centre of gravity of the aircraft is based on the combined weight of the plurality of payloads and the aircraft.

7. The multi-rotor aircraft according to claim 1, wherein the first position is defined by a change in combined weight of the plurality of payloads and the aircraft in such a way as to cause the first neutral point of the morphing mechanism to be out of alignment with the centre of gravity of the aircraft.

8. The multi-rotor aircraft according to claim 1, wherein the morphing mechanism further comprises a front portion and a rear portion, wherein the front portion includes more support arms than the rear portion.

9. The multi-rotor aircraft according to claim 8, wherein the rotation of the support arms by a predetermined angle about the vertical axis of the aircraft is symmetric about the x-z plane of the aircraft.

10. A multi-rotor aircraft for a multiple payload delivery comprising:
a morphing mechanism comprising an airframe and at least three support arms coupled to the airframe wherein each support arm is configured for rotating about a vertical axis of the aircraft relative to the morphing mechanism;
a payload bay coupled to the morphing mechanism for engaging and disengaging a plurality of payloads;
a control system communicatively coupled with the morphing mechanism and the payload bay, the control system configured to cause each of the support arms to rotate by a predetermined angle about the vertical axis of the aircraft, wherein the predetermined angle is determined based on a change in distance between a neutral point and a centre of gravity of the aircraft.

11. The multi-rotor aircraft according to claim 10, wherein the change in distance between a neutral point and a centre of gravity lies on a longitudinal axis of the aircraft.

12. The multi-rotor aircraft according to claim 11, wherein each of the support arms rotate by a predetermined angle about the vertical axis of the aircraft between a first position where the neutral point is out of alignment with the centre of gravity of the aircraft and a second position where the neutral point of the morphing mechanism is aligned with the centre of gravity of the aircraft.

13. The multi-rotor aircraft according to claim 1, wherein the first position is defined by a change in combined weight of the plurality of payloads and the aircraft in such a way as to cause the neutral point of the morphing mechanism to be out of alignment with the centre of gravity of the aircraft.

14. The multi-rotor aircraft according to claim 12, wherein the support arms are in a substantially Y-shaped configuration in the first position and the support arms are in a substantially T-shaped configuration in the second position.

15. The multi-rotor aircraft according to claim 12, wherein the support arms are in a substantially T-shaped configuration in the first position and the support arms are in a substantially Y-shaped configuration in the second position.

16. The multi-rotor aircraft according to claim 11, wherein the morphing mechanism further comprises a front portion and a rear portion, wherein the front portion includes more support arms than the rear portion.

17. The multi-rotor aircraft according to claim 16, wherein the rotation of the support arms by a predetermined angle in the front portion of the morphing mechanism about the vertical axis of the aircraft is symmetric about the x-z plane of the aircraft.

18. The multi-rotor aircraft according to claim 10, wherein each support arm comprises at least one propeller motor for rotating at least one propeller to cause lift of the aircraft.

19. A method of achieving neutral stability in a multi-rotor aircraft for a multiple payload delivery, comprising the steps of:
receiving, by a controller unit of the aircraft, a combined weight data defined by a combined weight of a plurality of payloads and the aircraft, wherein the aircraft comprises a morphing mechanism having an airframe and at least three support arms coupled to the airframe;
determining, by the controller unit, a change in distance between a neutral point location and a centre of gravity location,
determining, by the controller unit, whether there is a change in distance between the neutral point location and the centre of gravity location;
determining, by the controller unit, a predetermined angle defined by a change in angle of each support arm, in response to determining that there is a change in distance between the neutral point location and the centre of gravity location;
outputting a signal from the controller unit to one or more actuators for causing each support arm to rotate by the predetermined angle about a vertical axis of the aircraft between a first position where the neutral point location is out of alignment with the centre of gravity location and a second position where the neutral point location is aligned with the centre of gravity location of the aircraft.

20. The method according to claim 19, wherein the first position is defined by a change in combined weight of the plurality of payloads and the aircraft in such a way as to cause the neutral point of the morphing mechanism to be out of alignment with the centre of gravity of the aircraft.

21. The method according to claim 19, wherein the support arms are in a substantially Y-shaped configuration in the first position and the support arms are in a substantially T-shaped configuration in the second position.

22. The method according to claim 19, wherein the support arms are in a substantially T-shaped configuration in the first position and the support arms are in a substantially Y-shaped configuration in the second position.

23. The method according to claim 19, wherein the rotation of the support arms by a predetermined angle in the front portion of the morphing mechanism about the vertical axis of the aircraft is symmetric about the x-z plane of the aircraft.
